(19) United States
(12) Patent Application Publication
(10) Pub. No.: US 2021/0238432 A1
(43) Pub. Date: Aug. 5, 2021

(54) INK, INKJET INK, INK CONTAINER, IMAGE FORMING METHOD, AND IMAGE FORMING DEVICE

(71) Applicants: Toru YOSHIKAWA, Kanagawa (JP); Yuuki YOKOHAMA, Kanagawa (JP); Takashi TAMAI, Kanagawa (JP); Satoshi TAKAHASHI, Kanagawa (JP); Sayuri KOJIMA, Kanagawa (JP); Atsufumi HANAZAWA, Tokyo (JP); Azumi MIYAAKE, Tokyo (JP); Yukihiro IMANAGA, Kanagawa (JP); Koichiro OYAMA, Kanagawa (JP); Kento SUGITA, Tokyo (JP); Mizuki KUROHA, Kanagawa (JP)

(72) Inventors: Toru YOSHIKAWA, Kanagawa (JP); Yuuki YOKOHAMA, Kanagawa (JP); Takashi TAMAI, Kanagawa (JP); Satoshi TAKAHASHI, Kanagawa (JP); Sayuri KOJIMA, Kanagawa (JP); Atsufumi HANAZAWA, Tokyo (JP); Azumi MIYAAKE, Tokyo (JP); Yukihiro IMANAGA, Kanagawa (JP); Koichiro OYAMA, Kanagawa (JP); Kento SUGITA, Tokyo (JP); Mizuki KUROHA, Kanagawa (JP)

(21) Appl. No.: 17/165,134

(22) Filed: Feb. 2, 2021

(30) Foreign Application Priority Data
Feb. 4, 2020 (JP) 2020-017384

(51) Int. Cl. C09D 11/322; B41M 5/00; C09D 11/037; C09D 11/033; C09D 11/107

(52) U.S. Cl. CPC C09D 11/322; B41M 5/0023; G06K 15/102; C09D 11/033; C09D 11/107; C09D 11/037

(57) ABSTRACT

An ink contains water, an organic solvent, a resin, and a pigment, wherein the organic solvent has a Hansen solubility parameter (HSP) value in a Hansen sphere in a δD axis, δP axis, and δH axis coordinate space of a solid content of the ink.

### CROSS-REFERENCE TO RELATED APPLICATIONS

This patent application is based on and claims priority pursuant to 35 U.S.C. § 119 to Japanese Patent Application No. 2020-017384 filed on Feb. 4, 2020 in the Japan Patent Office, the entire disclosure of which is hereby incorporated by reference herein.

### BACKGROUND

### Technical Field

The present disclosure relates to an ink, an inkjet ink, an ink container, an image forming method, and an image forming device.

### Description of the Related Art

Inkjet recording methods have advantages such that the process is simple and full colorization is easy. Therefore, high resolution images can be obtained by a device having a simple configuration. For this reason, the inkjet recording is widely diffusing from home use to office use, commercial printing, and industrial printing.

As the inkjet ink, dye inks have been mainly used to demonstrate good coloring and high reliability. Such dye inks have poor water-resistance and light resistance. For this reason, pigment inks have become popular for use in inkjet printing.

Pigment inks are now used in commercial printing using a high performance continuous printing machine and contain resins to achieve quick drying (high speed fixability) required for such a high performance continuous printing machine and good fixability to recording media having poor ink absorbency.

The pigments and resins in pigment inks containing resins readily adhere to recording heads and quickly aggregate and dry thereon during continuous printing so that the discharging stability of the ink may deteriorate. Moisture in the ink evaporates from the nozzles of a head idle for a long period of time; the ink may thicken and fixate on the nozzles, the dischargeability of the ink deteriorates, and the ink may not be discharged from the head.

High speed printing is inevitable in industrial settings because printing in industrial settings is required to be productive in comparison with consumer printing. Line head printers have been developed to achieve such high performance printing. This high performance printing is possible because the heads of line head printers are fixed while recording media are scanned. On the other hand, serial head printers move the heads multiple times during printing.

If a nozzle in a serial head printer fails to discharge ink, the other nozzles covers for the non-discharging nozzle without degrading the quality of images because the serial printers move the head multiple times. On the other hand, if a nozzle in a line head printer fails to discharge ink, the quality of images printed with the line head printer deteriorates because the head of the line head printer passes a recording medium only once. Improvement on discharging stability is extremely necessary for image forming methods using a ling head printer.

Research and development of ink have been made with a focus on special materials such as a solvent, pigment dispersion, and fixing resin to secure discharging stability of the ink.

### SUMMARY

According to embodiments of the present disclosure, provided is an ink which contains water, an organic solvent, a resin, and a pigment, wherein the organic solvent has a Hansen solubility parameter (HSP) value in a Hansen sphere in a δD axis, δP axis, and δH axis coordinate space of a solid content of the ink.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of an image forming device using the ink according to an embodiment of the present disclosure; and

FIG. 2 is a diagram illustrating a perspective view of a tank that accommodates the ink according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an ink can be provided which has excellent discharging stability (discharging reliability).

Ink

The organic solvent, water, coloring material, resin, and additive for use in the ink are described below.

Solvent Mixture

A solvent mixture contains an organic solvent and water. The HSP value of the organic solvent in an ink is required to be within a Hansen sphere in the δD axis, δP axis, and δH axis coordinate space of the solid content of the ink. The HSP value of the solvent mixture is preferably within the Hansen sphere in the δD axis, δP axis, and δH axis coordinate space of the solid content of the ink.

If the HSP value of a solvent mixture is not within the Hansen sphere in the δD axis, δP axis, and δH axis coordinate space of the solid content of the ink, the ink cannot maintain a normal state as ink because the pigments or resins dispersed in the ink may precipitate or the organic solvent and water may be separated from each other.

A center coordinate of the Hansen sphere having a δD value of from 15 to 18, a δP value of from 10 to 18, and a δH value of from 27 to 38 provides an ink having excellent discharging stability.

As the distance between the HSP value of a solvent and the center of a Hansen sphere of the solid content of an ink decreases in the δD axis, δP axis, and δH axis coordinate space, the solvent becomes compatible with the solid content of the ink. If the compatibility is high, the ink is stable because the solid content never or little precipitates in the ink or separates from the solvent.

The ink preferably satisfies the following relationship: (b)−(a)≥2.4, where (b) represents the value of δH of the HSP value of the organic solvent and (a) represents the value calculated by subtracting the radius of the Hansen sphere in the δD axis, δP axis, and δH axis coordinate space of the solid content of the ink from δH of the Hansen sphere in the δD axis, δP axis, and δH axis coordinate space of the solid content of the ink.

Hansen Solubility Parameter

The Hansen solubility parameter (HSP) is represented in a three dimensional space using three components of the dispersion term (δD), polarity term (δP), and hydrogen bond term (δH) obtained by dividing the solubility parameter (SP) introduced by Hidebrand. The dispersion term (δD) represents the effect by the dispersion force, the polarity term (δP) represents the effect by the dipole force, and the hydrogen bond term (δH) represents the effect by the hydrogen bonding strength.

The definition and calculation of the HSP are described in the following document.

Hansen Solubility Parameters: A Users Hand book (authored by Charles M. Hansen, published by CRC Press in 2007).

The HSP value (δD), (δP), and (δH) is readily estimated on a basis of its chemical structure by using the computer software of Hansen Solubility Parameters in Practice (HSPiP). In the present disclosure, the values of the solvents registered in the database of HSPiP version 4.1.06 are used as they are and the values of the solvents not registered in the database are estimated by HSPiP version 4.1.06.

Each of the three values of (δD), (δP), and (δH) of the HSP value of a solvent mixture can be obtained by subjecting the volume ratio and HSP values of each component in the solvent mixture to weighted average.

The type and the percentage of a solvent mixture can be identified by gas chromatography-mass spectrometry (GCMS). The ink is subjected to GCMS for qualitative analysis of the solvents contained therein. When the type is identified, the calibration curve of the concentration of each organic solvent is created for obtaining the amount of each organic solvent in the ink.

Organic Solvent

There is no specific limit to the selection of the solvent as long as the HSP can be adjusted. The solvent can be suitably selected to suit to a particular application.

Organic Solvent

There is no specific limitation to the organic solvent for use in the present disclosure. For example, a water-soluble organic solvent can be used. Examples include, but are not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-butoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent having a boiling point of 250 or lower degrees C., which serves as a humectant and imparts a good drying at the same time.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

The polyhydric alcohol or polyol compounds having eight or more carbon atoms and glycolether compounds enhance permeability of ink for paper used as a recording medium.

The proportion of the organic solvent in the ink has no particular limit and can be suitably selected to suit to a particular application.

In terms of drying and discharging reliability of the ink, the proportion is preferably from 10 to 60 percent by mass and more preferably from 20 to 60 percent by mass.

Water

The proportion of water of the ink is not particularly limited and can be suitably selected to suit to a particular application. For example, in terms of enhancing the drying and discharging reliability of the ink, the proportion is preferably from 10 to 90 percent by mass and more preferably from 20 to 60 percent by mass.

Coloring Material

The pigment includes an inorganic pigment or an organic pigment. These can be used alone or in combination. In addition, a mixed crystal can also be used as the coloring material.

Examples of the pigments include, but are not limited to, black pigments, yellow pigments, magenta pigments, cyan pigments, white pigments, green pigments, orange pigments, and gloss or metallic pigments of gold, silver, and others.

Carbon black manufactured by known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigment include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of those pigments, pigments having good affinity with solvents are preferable. Also, hollow resin particles and hollow inorganic particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The proportion of the coloring material in the ink is preferably from 0.1 to 15 percent by mass and more preferably from 1 to 10 percent by mass in terms of enhancement of image density, fixability, and discharging stability.

The ink is obtained by introducing a hydrophilic functional group into a pigment to prepare a self-dispersible pigment, coating the surface of a pigment with a resin followed by dispersion, or using a dispersant to disperse a pigment.

One way of preparing a self-dispersible pigment by introducing a hydrophilic functional group into a pigment is to add a functional group such as a sulfone group and carboxyl group to a pigment (e.g., carbon) to disperse the pigment in water.

One way of dispersing a resin by coating the surface thereof is to encapsulate a pigment in a microcapsule to make it disperse in water. This can be referred to as a resin-coated pigment. In this case, all the pigments to be added to ink are not necessarily entirely coated with a resin. Pigments partially or wholly uncovered with a resin are allowed to be dispersed in the ink unless such pigments have an adverse impact.

When a dispersant is used, a known dispersant having a small or large molecular weight represented by a surfactant is used.

It is possible to select an anionic surfactant, a cationic surfactant, a nonionic surfactant, an amphoteric surfactant, or others depending on a pigment.

Also, a nonionic surfactant (RT-100, manufactured by TAKEMOTO OIL & FAT CO., LTD.) and a formalin condensate of naphthalene sodium sulfonate are suitable as the dispersant.

Those can be used alone or in combination.

Pigment Dispersion

The ink can be obtained by mixing a pigment with materials such as water and an organic solvent. It is also possible to mix a pigment with water, a dispersant, and other substances to prepare a pigment dispersion and thereafter mix the pigment dispersion with materials such as water and an organic solvent to manufacture an ink.

The pigment dispersion is obtained by mixing and dispersing water, a pigment, a pigment dispersant, and other optional components and controlling the particle size. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of the pigment can be analyzed using a particle size analyzer (Nanotrac Wave-UT151, manufactured by MicrotracBEL Corp).

The proportion of the pigment in the pigment dispersion is not particularly limited and can be suitably selected to suit a particular application. In terms of improving discharging stability and image density, the proportion is preferably from 0.1 to 50 percent by mass and more preferably from 0.1 to 30 percent by mass.

It is preferable that the pigment dispersion be filtered with an instrument such as filter and a centrifuge to remove coarse particles followed by deaerateing.

Resin

The type of the resin contained in the ink has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to mix a resin emulsion in which such resin particles are dispersed in water as a dispersion medium with materials such as a coloring material and an organic solvent to obtain an ink. It is possible to use suitably-synthesized resin particles as the resin particle. Alternatively, the resin particle available on the market can be used. The resin particle can be used alone or in combination.

The mean volume diameter (i.e., volume average particle diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve good fixability and image robustness.

The volume average particle diameter can be measured by using, for example, a particle size analyzer (Nanotrac Wave-UT151, manufactured by MicrotracBEL Corp.).

The proportion of the resin in the ink is not particularly limited and can be suitably selected to suit to a particular application. In terms of fixability and storage stability of the ink, it is preferably from 1 to 30 percent by mass and more preferably from 5 to 20 percent by mass of the total amount of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as image density. The solid portion includes particles such as resin particles and pigment particles. The particle diameter can be measured by using a particle size analyzer (Nanotrac Wave-UT151, manufactured by MicrotracBEL Corp).

Additive

The ink may further optionally include additives such as a surfactant, a defoaming agent, a preservative and fungicide, a corrosion inhibitor, and a pH regulator.

### Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, surfactants not decomposable in a high pH environment are preferable. Examples of the silicone-based surfactants include, but are not limited to, side chain modified polydimethyl siloxane, both terminal-modified polydimethyl siloxane, one-terminal-modified polydimethyl siloxane, and side-chain-both-terminal-modified polydimethyl siloxane. In particular, silicone-based surfactants having a polyoxyethylene group or a polyoxyethylene polyoxypropylene group as a modification group are particularly preferable because such an aqueous surfactant demonstrates good properties. It is possible to use a polyether-modified silicone-based surfactant as the silicone-based surfactant. A specific example is a compound in which a polyalkylene oxide structure is introduced into the side chain of the Si site of dimethyl siloxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both distal-end-modified polydimethyl siloxane, one-distal-end-modified polydimethyl siloxane, and side-chain-both-distal-end-modified polydimethyl siloxane. In particular, a polyether-modified silicone-based surfactant having a polyoxyethylene group or a polyoxyethylene polyoxypropylene group is particularly preferable because such a surfactant demonstrates good property as an aqueous surfactant.

Such surfactants can be synthesized or procured. Products are available from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical Formula S-1 is introduced into the side chain of the Si site of dimethyl polysiloxane.

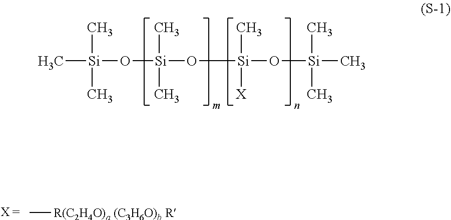

In Chemical Formula S-1, “m”, “n”, “a”, and “b” each, respectively independently represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because these do not easily foam and the fluorochemical surfactant represented by the following Chemical Formula F-1 or Chemical Formula F-2 is preferable.

CF₃CF₂(CF₂CF₂)ₘ—CH₂CH₂O(CH₂CH₂O)ₙH F-1

In the Chemical Formula F-1, “m” is preferably 0 or an integer of from 1 to 10 and “n” is preferably 0 or an integer of from 1 to 40.

CₙF₂ₙ₊₁—CH₂CH(OH)CH₂—O—(CH₂CH₂O)ₐ—Y F-2

In the compound represented by the Chemical Formula F-2, Y represents H or CₘF₂ₘ₊₁, where n represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19. n represents an integer of from 1 to 6. a represents an integer of from 4 to 14.

The fluorochemical surfactant is commercially available. Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant in the ink is not particularly limited and can be suitably selected to suit to a particular application. For example, the proportion is preferably from 0.001 to 5 percent by mass and more preferably from 0.05 to 5 percent by mass to achieve excellent wettability and discharging stability and improve image quality.

### Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to achieve the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Examples include, but are not limited to, acid sulfites and sodium thiosulfates.

pH Regulator

The pH regulator has no particular limit as long as it can control pH to be not lower than 7. Specific examples include, but are not limited to, amines such as diethanol amine and triethanol amine.

Solid Content of Ink

How to obtain the Hansen sphere of the solid portion containing the pigment and the resin in an ink is described below.

First, the ink is concentrated. The concentrate of the ink is obtained by removing the solvent in the ink. The solvent can be removed in various ways. One way of removing the solvent is to rest the ink under the normal pressure or use a device such as an evaporator under a reduced pressure. It is preferable to remove the solvent in the temperature range of from 20 to 70 degrees C. The solvent is removed until the mass ratio of the mass after the concentration to the mas of the ink before the removal of the solvent becomes 40 percent by mass.

Twelve types of solvents shown in the following Table 1 are prepared. A total of 4.0 g of each solvent is mixed with 4.0 g of the concentrate of the ink followed by stirring for 10 minutes, so that samples of the compositions of the twelve types are prepared. The samples are left still at 25 degrees C. for 24 hours.

Thereafter, the samples of the twelve types are visually checked. If no precipitate is present, it is classified as good solvent. If a precipitate is present, it is classified as poor solvent.

The HSP values of the solvent and the classification result are input into HSPiP to obtain the center coordinate and the radius on the HSP sphere. The thus-obtained values are defined as the center coordinate and the radius of the Hansen sphere of the solid content of the ink.

TABLE 1

| | HSP value [(J/cm³)^{0.5}] | | |
|---|---|---|---|
| Solvent | δD | δP | δH |
| Water | 15.5 | 16.0 | 42.3 |
| 1,2-Propane diol | 16.8 | 10.4 | 21.3 |
| 1,3-Propane diol | 16.8 | 13.5 | 23.2 |
| 1,3-Butane diol | 16.5 | 8.1 | 20.9 |
| 2,3-Butane diol | 17.0 | 7.6 | 18.3 |
| 3-Methoxy-3-methyl-1-butanol | 16.0 | 6.3 | 12.9 |
| Glycerin | 17.4 | 11.3 | 27.2 |
| 3-Methoxy-N,N-dimethyl | 17.2 | 11.0 | 9.5 |
| propionamide | | | |
| Dipropylene glycol | 16.5 | 10.6 | 17.7 |
| 3-Methyl-1,3-butane diol | 16.8 | 8.0 | 16.9 |
| Octane diol | 16.4 | 6.2 | 14.0 |
| THF | 16.8 | 5.7 | 8.0 |

Property of Ink

Properties of the ink are not particularly limited and can be suitably selected to suit to a particular application. For example, viscosity, surface tension, and pH are preferable in the following ranges.

Viscosity of the ink at 25 degrees C. is preferably from 5 to 30 mPa·s and more preferably from 5 to 25 mPa·s because print density and text quality improve and good dischargeability is demonstrated. Viscosity can be measured by, for example, a rotatory viscometer (RE-80L, manufactured by TOKI SANGYO CO., LTD.). The measuring conditions are as follows:
Standard cone rotor (1° 34′×R24)
Sample liquid amount: 1.2 mL
Rotational frequency: 50 rotations per minute (rpm)
25 degrees C.
Measuring time: three minutes.

The surface tension of the ink is preferably 35 mN/m or less and more preferably 32 mN/m or less at 25 degrees C. because the ink suitably levels on a recording medium and the ink is dried in a shorter time.

pH of the ink is preferably from 7 to 12 and more preferably from 8 to 11 in terms of prevention of corrosion of metal material in contact with liquid.

Pre-Processing Fluid

The pre-processing fluid includes a flocculant, an organic solvent, water, and optional materials such as a surfactant, a defoaming agent, a pH regulator, a preservatives and fungicides, and a corrosion inhibitor.

The organic solvent, the surfactant, the defoaming agent, the pH regulator, the preservatives and fungicides, and the corrosion inhibitor can be the same material as those for use in ink. Other material for use in known processing fluid can be used.

The type of the flocculant is not particularly limited. For example, water-soluble cationic polymers, acids, and multi-valent metal salts are suitable.

Post-Processing Fluid

The post-processing fluid has no particular limit. It is preferable that the post-processing fluid can form a transparent layer. Material such as organic solvents, water, resins, surfactants, defoaming agents, pH regulators, preservatives and fungicides, corrosion inhibitors, etc. is suitably selected based on a necessity basis and mixed to obtain the post-processing fluid. The post-processing fluid can be applied to the entire recording area formed on a recording medium or only the area on which an ink image is formed.

Recording Medium

The recording medium is not particularly limited. Materials such as plain paper, gloss paper, special paper, and cloth are usable. Also, good images can be formed on a non-permeable substrate.

The non-permeable substrate has a surface with low moisture permeability and absorbency and includes a material having a number of hollow spaces inside that are not open to the outside. To be more quantitative, the substrate has a water-absorbency of 10 or less mL/m² from the start of the contact until 30 msec^{1/2} later according to Bristow's method.

For example, plastic films such as vinyl chloride resin film, polyethylene terephthalate (PET) film, polypropylene film, polyethylene film, and polycarbonate film are suitably used as the non-permeable substrate.

The recording media are not limited to typical recording media and suitably include building materials such as wall paper, floor material, and tiles, cloth for apparel such as T-shirts, textile, and leather. The configuration of the paths through which the recording medium is conveyed can be changed to use materials such as ceramics, glass, and metal.

Recorded Matter

The ink recorded matter of the present disclosure includes a recording medium and an image formed on the recording medium with the ink of the present disclosure.

The recorded matter is obtained by an inkjet recording device executing an inkjet recording method.

Recording Device and Recording Method

The ink the ink set of the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices such as 3D printers and additive manufacturing devices.

In the present disclosure, the recording device and the recording method respectively represent a device capable of discharging ink and liquids such as various processing fluids to a recording medium and a method of recording utilizing such a device. The recording medium means an item to which ink or various processing fluids can be temporarily or permanently attached.

The recording device may further optionally include a device relating to feeding, conveying, and ejecting a recording medium and other devices referred to as a pre-processing device, a post-processing device in addition to the head portion to discharge the ink.

The recording device and the recording method may further optionally include a heating device (heater) for use in the heating process and a drying device (drier) for use in the drying process. For example, the heating device and the drying device heat and dry the print surface and the opposite surface of a recording medium. The heating device and the drying device are not particularly limited. For example, a fan heater and an infra-red heater can be used. It is possible to heat and dry a recording medium before, during, and after printing.

In addition, the recording device and the recording method are not limited to those producing meaningful visible images such as texts and figures with ink. For example, the recording method and the recording device capable of producing patterns like geometric design and 3D images are included.

In addition, the recording device includes both a serial type device in which the discharging head moves and a line type device in which the discharging head is not moved, unless otherwise specified.

Furthermore, in addition to the desktop type, this recording device includes a device capable of printing images on a wide recording medium such as AO and a continuous printer capable of using continuous paper reeled up in a roll form as recording media.

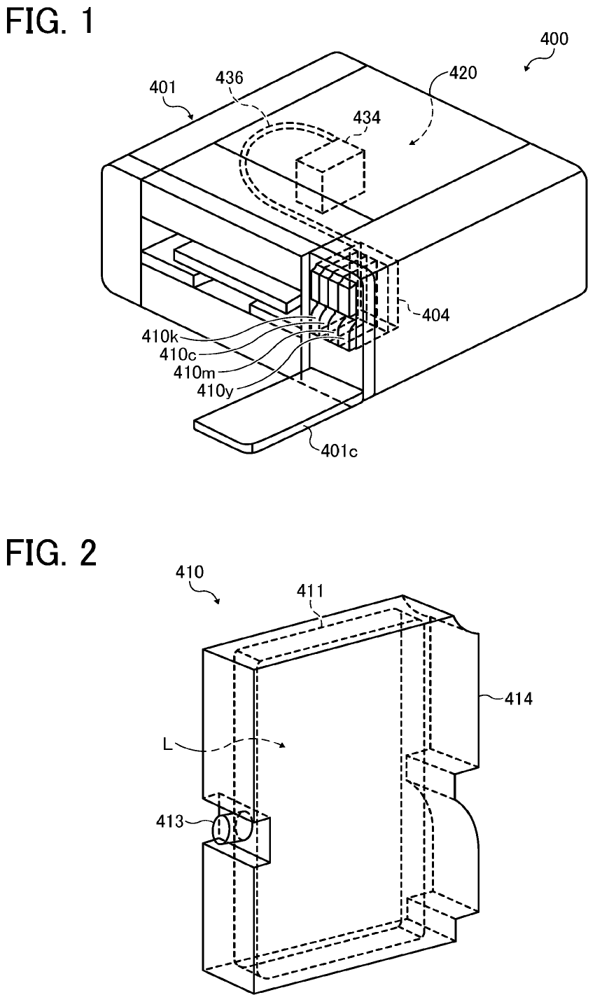

The recording device is described using an example with reference to FIG. 1 and FIG. 2. FIG. 1 is a diagram illustrating a perspective view of the recording device. FIG. 2 is a diagram illustrating a perspective view of a tank. An image forming device 400, which is an embodiment of the recording device, is a serial type image forming device. A mechanical assembly 420 is disposed in an exterior 401 of the image forming device 400. Each ink container 411 of each container (tank) 410 (410k, 410c, 410m, and 410y) for each color of black (K), cyan (C), magenta (M), and yellow (Y) is made of, for example, a packaging member such as aluminum laminate film. The ink container 411 is housed in, for example, a plastic container housing unit 414 and L represents liquid contained in the ink container 411. As a result, the tank 410 is used as an ink cartridge of each color.

A cartridge holder 404 is disposed on the rear side of the opening formed when a cover 401c is opened. The cartridge holder 404 is detachably attached to the tank 410. In this configuration, each ink discharging outlet 413 of the tank 410 communicates with a discharging head 434 for each color via a supplying tube 436 for each color and the ink can be discharged from the discharging head 434 to a recording medium.

This recording device may include not only a portion for discharging ink but also a device referred to as a pre-processing device and a post-processing device.

As an example of the pre-processing device and the post-processing device, like the ink of black (K), cyan (C), magenta (M), and yellow (Y) ink, the pre-processing device and the post-processing device may further include a liquid accommodating unit including a pre-processing liquid or a post-processing liquid and a liquid discharging head to discharge the pre-processing liquid or the post-processing liquid according to an inkjet printing method.

As another example of the pre-processing device and the post-processing device, it is suitable to dispose a pre-processing device and a post-processing device not employing the inkjet printing method but a blade coating method, a roll coating method, or a spray coating method.

Notably, the ink is applicable not only to the inkjet recording but can be widely applied in other methods.

Specific examples of such methods other than the inkjet recording include, but are not limited to, blade coating methods, gravure coating methods, bar coating methods, roll coating methods, dip coating methods, curtain coating methods, slide coating methods, die coating methods, and spray coating methods.

The usage of the ink of the present disclosure is not particularly limited and can be suitably selected to suit to a particular application. For example, the ink can be used for printed matter, a paint, a coating material, and foundation. The ink can be used to produce two-dimensional text and images and furthermore used as a material for solid fabrication for manufacturing a solid fabrication object (or solid freeform fabrication object).

The solid fabrication apparatus to fabricate a solid fabrication object can be any known device with no particular limit. For example, the apparatus includes a container, supplying device, discharging device, drier of ink, and others. The solid fabrication object includes an object manufactured by repetitively coating ink. In addition, the solid fabrication object includes a mold-processed product manufactured by processing a structure having a substrate such as a recording medium to which the ink is applied. The mold-processed product is manufactured from recorded matter or a structure having a form such as a sheet-like form, and film-like form. by, processing such as heating drawing or punching. The molded processed product is suitably used for articles which are molded after surface-decorating. Examples are gauges or operation panels of vehicles, office machines, electric and electronic devices, cameras, etc.

Terms such as image forming, recording, printing, and print used in the present disclosure represent the same meaning.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples but not limited thereto.

### Preparation Example 1 of Liquid Dispersion of Pigment

Preparation of Liquid Dispersion of Black Pigment

After the following recipe was preliminarily mixed, the mixture was subjected to circulation dispersion for seven hours with a disk type bead mill (KDL type, media: zirconia ball having a diameter of 0.3 mm, manufactured by SHINMARU ENTERPRISES CORPORATION) so that a black pigment dispersion (pigment concentration: 15 percent by mass) was obtained.
Carbon black pigment (Monarch 800, manufactured by Cabot Corporation): 15 parts
Anionic surfactant (Pionine A-51-B, manufactured by TAKEMOTO OIL & FAT Co., Ltd.): 2 parts
Deionized water: 83 parts

### Preparation Example 2 of Liquid Dispersion of Pigment

Preparation of Liquid Dispersion of Cyan Pigment

A liquid dispersion of cyan pigment (concentration of pigment solid content: 15 percent by mass) was obtained in the same manner as in Preparation Example 1 of Liquid Dispersion of Pigment except that the carbon black pigment was changed to Pigment Blue 15:3 (Product: LIONOL BLUE FG-7351, manufactured by TOYO INK CO., LTD.).

### Preparation Example 3 of Liquid Dispersion of Pigment

Preparation of Liquid Dispersion of Magenta Pigment

A liquid dispersion of magenta pigment (concentration of pigment solid content: 15 percent by mass) was obtained in the same manner as in Preparation Example 1 of Pigment Dispersion except that the carbon black pigment was changed to Pigment Red 122 (Product: TONER MAGENTA E002, manufactured by Clariant Japan K.K.).

### Preparation Example 4 of Liquid Dispersion of Pigment

### Preparation Example of Yellow Pigment Liquid Dispersion

A liquid dispersion of yellow pigment (pigment solid concentration of 15 percent by mass) was prepared in the same manner as in Preparation Example 1 of Liquid Dispersion of Pigment except that the carbon black pigment was replaced with Pigment Yellow 74 (Fast Yellow 531, available from Dainichiseika Color & Chemicals Mfg. Co., Ltd.).

### Example 1

Preparation of Ink

A mixture of an acrylic resin emulsion (VONCOAT R-3380-E, solid portion concentration of solid content at 45 percent by mass, manufactured by DIC Corporation) at 5 percent by mass in solid content conversion, 1,2-propane diol at 15 percent by mass, glycerin at 15 percent by mass, a fluorochemical surfactant (ZONYL™ FSO-100, manufactured by E.I. du Pont de Nemours and Company) at 1 percent by mass, a black pigment dispersion at 20 percent by mass, and a balance of deionized water for making the total 100 percent was prepared and stirred for one hour. Coarse particles were removed from the mixture by filtering under a pressure using a polypropylene filter (Profile Star, manufactured by Nihon Pall Manufacturing Ltd.) having an average pore diameter of 1.5 μm. An Ink 1 was thus prepared.

Calculation of HSP Value

The HSP Values are calculated from the ratio of 1,2-propane diol, glycerin, and deionized water and the HSP values in the following manner. The calculation results are shown in Table 3.

Organic Solvent+Water

δD=15/(15+15+44)×16.8+15/(15+15+44)×17.4+44/(15+15+44)×15.5=16.1

δP=15/(15+15+44)×10.4+15/(15+15+44)×11.3+44/(15+15+44)×16.0=13.9

δH=15/(15+15+44)×21.3+15/(15+15+44)×27.2+44/(15+15+44)×42.3=35.0

Organic Solvent

δD=15/(15+15)×16.8+15/(15+15)×17.4=17.1

δP=15/(15+15)×10.4+15/(15+15)×11.3=10.9

δH=15/(15+15)×21.3+15/(15+15)×27.2=24.3

### Examples 2 to 12 and Comparative Examples 1 to 6

Preparation of Ink

Inks of Examples 2 to 12 and Comparative Examples 1 to 6 were manufactured in the same manner as in Example 1 except that the compositions and the contents were changed as shown in Tables 2-1 and 2-2.

The HSP values were calculated in the same manner as in Example 1. The calculation results are shown in Table 3.

The calculation method for determining whether the HSP values of an organic solvent is within the Hansen sphere of the solid content is as follows.

Solvent Mixture of Organic Solvent and Water

Calculate the distance between the point of HSP value of a solvent mixture in the δD axis, δP axis, and δH axis coordinate space and the center point of the Hansen sphere of the solid content.

On a basis of the definition of the coordinate of the center point of Hansen sphere of the solid content as (D1, P1, H1) and the coordinate of the HSP value of the solvent mixture as (D2, P2, H2), the distance between the two points are calculated according to the following relationship.

((D1−D2)²+(P1−P2)²+((H1−H2)²)^{0.5}

If the radius of the Hansen sphere of the solid content is larger than the distance between the two points, the HSP value of the solvent mixture is regarded as within the Hansen sphere.

Organic Solvent

The distance between the point of the HSP value of an organic solvent and the center point of the solid content of Hansen sphere is calculated.

On a basis of the definition of the coordinate of the center point of Hansen sphere of the solid content as (D1, P1, H1) and the coordinate of the HSP value of the organic solvent as (D2, P2, H2), the distance between the two points are calculated according to the following relationship.

((D1−D2)²+(P1−P2)²+(H1−H2)²)^{0.5}

If the radius of the Hansen sphere is larger than the distance between the two points, the HSP value of the organic solvent is regarded as within the Hansen sphere.

TABLE 2-1

| | Example | | | | | | | | |
|---|---|---|---|---|---|---|---|---|---|
| Recipe | 1 | 2 | 3 | 4 | 5 | 6 | 7 | 8 | 9 |
| VONCOAT | 5 | 5 | 5 | 5 | 5 | 5 | 5 | 5 | 5 |
| R-3380-E | percent | percent | percent | percent | percent | percent | percent | percent | percent |
| ACRIT | — | — | — | — | — | — | — | — | — |
| WBR-016U | | | | | | | | | |
| Black | 20 | — | — | — | — | 20 | — | — | — |
| pigment | percent | | | | | percent | | | |
| dispersion | | | | | | | | | |
| Yellow | — | 20 | — | — | — | — | 20 | — | — |
| pigment | | percent | | | | | percent | | |
| dispersion | | | | | | | | | |
| Magenta | — | — | 20 | — | — | — | — | 20 | — |
| pigment | | | percent | | | | | percent | |
| dispersion | | | | | | | | | |
| Cyan | — | — | — | 20 | — | — | — | — | 20 |
| pigment | | | | percent | | | | | percent |
| dispersion | | | | | | | | | |
| Liquid | — | — | — | — | 20 | — | — | — | — |
| dispersion of | | | | | percent | | | | |
| pigment: | | | | | | | | | |
| 465M | | | | | | | | | |
| Liquid | — | — | — | — | — | — | — | — | — |
| dispersion of | | | | | | | | | |
| pigment: 400 | | | | | | | | | |
| 1,2-Propane | 15 | 15 | 15 | 15 | 15 | — | — | — | — |
| diol | percent | percent | percent | percent | percent | | | | |
| 1,3-Propane | — | — | — | — | — | 25 | 25 | 25 | 25 |
| diol | | | | | | percent | percent | percent | percent |
| Glycerin | 15 | 15 | 15 | 15 | 15 | 5 | 5 | 5 | 5 |
| | percent | percent | percent | percent | percent | percent | percent | percent | percent |
| Surfactant | 1 | 1 | 1 | 1 | 1 | 1 | 1 | 1 | 1 |
| | percent | percent | percent | percent | percent | percent | percent | percent | percent |
| Deionized | 44 | 44 | 44 | 44 | 44 | 44 | 44 | 44 | 44 |
| water | percent | percent | percent | percent | percent | percent | percent | percent | percent |

TABLE 2-2

| | Example | | | Comparative Example | | | | | |
|---|---|---|---|---|---|---|---|---|---|
| Recipe | 10 | 11 | 12 | 1 | 2 | 3 | 4 | 5 | 6 |
| VONCOAT | 5 | — | — | 5 | 5 | — | — | — | — |
| R-3380-E | percent | | | percent | percent | | | | |
| ACRIT | — | 5 | 5 | — | — | 5 | 5 | 5 | 5 |
| WBR-016U | | percent | percent | | | percent | percent | percent | percent |
| Black | — | — | — | — | — | 20 | — | — | — |
| pigment | | | | | | percent | | | |
| dispersion | | | | | | | | | |
| Yellow | — | — | — | — | — | — | 20 | — | — |
| pigment | | | | | | | percent | | |
| dispersion | | | | | | | | | |
| Magenta | — | — | — | 20 | — | — | — | 20 | — |
| pigment | | | | percent | | | | percent | |
| dispersion | | | | | | | | | |
| Cyan | — | — | — | — | 20 | — | — | — | 20 |
| pigment | | | | | percent | | | | percent |
| dispersion | | | | | | | | | |
| Liquid | 20 | 20 | — | — | — | — | — | — | — |
| dispersion of | percent | percent | | | | | | | |
| pigment: | | | | | | | | | |
| 465M | | | | | | | | | |
| Liquid | — | — | 20 | — | — | — | — | — | — |
| dispersion of | | | percent | | | | | | |
| pigment: 400 | | | | | | | | | |
| 1,2-Propane | — | 15 | 15 | 30 | 30 | 15 | 15 | 15 | 15 |
| diol | | percent | percent | percent | percent | percent | percent | percent | percent |
| 1,3-Propane | 25 | — | — | — | — | — | — | — | — |
| diol | percent | | | | | | | | |
| Glycerin | 5 | 15 | 15 | — | — | 15 | 15 | 15 | 15 |
| | percent | percent | percent | | | percent | percent | percent | percent |
| Surfactant | 1 | 1 | 1 | 1 | 1 | 1 | 1 | 1 | 1 |
| | percent | percent | percent | percent | percent | percent | percent | percent | percent |
| Deionized | 44 | 44 | 44 | 44 | 44 | 44 | 44 | 44 | 44 |
| water | percent | percent | percent | percent | percent | percent | percent | percent | percent |

TABLE 3

| | HSP value (J/cm³)^{0.5} of solvent | | | | | | |
|---|---|---|---|---|---|---|---|
| | Organic solvent + water | | | → | Organic solvent alone | | |
| | δD | δP | δH | | δD | δP | δH (b) |
| Examples 1 to 5, 11 and 12 | 16.1 | 13.9 | 35.0 | → | 17.1 | 10.9 | 24.3 |
| and Comparative Examples | | | | | | | |
| 3 to 6 | | | | | | | |
| Example 6 to 10 | 16.1 | 14.8 | 34.8 | | 16.9 | 13.1 | 23.9 |
| Comparative Examples 1 | 16.0 | 13.7 | 33.8 | | 16.8 | 10.4 | 21.3 |
| and 2 | | | | | | | |

In Tables 2-1 and 2-2, the product names and the manufacturing companies of the ingredients are as follows.
ACRIT WBR-016U: polyether-based urethane resin emulsion (concentration of solid portion: 30 percent by mass, manufactured by TAISEI FINE CHEMICAL CO., LTD.)
465 M: Liquid dispersion of magenta aqueous pigment: CAB-O-JET 465M, concentration of solid portion: 14.9 percent by mass, manufactured by Cabot Corporation
400: Liquid dispersion of black aqueous pigment: CAB-O-JET 400, concentration of solid portion: 14.9 percent by mass, manufactured by Cabot Corporation

Discharging Stability

The discharging stability of the ink was evaluated using the inkjet printer (remodeled IPSiO GXe5500, manufactured by Ricoh Co., Ltd.). The evaluation results are shown in Table 4.

The inkjet printer (remodeled IPSiO GXe5500, manufactured by Ricoh Co., Ltd.) was filled with the obtained ink and a nozzle check pattern was printed for checking whether nozzle omission had not occurred. The inkjet printer was left to rest for 12 hours. Thereafter, the nozzle check pattern was printed without cleaning maintenance. The discharging stability of the ink was evaluated on a basis of the number of nozzle omissions according to the following evaluation criteria. B and above in the evaluation are preferable for practical purposes. Nozzle omission means that ink is not discharged and no ink image is printed properly.

Evaluation Criteria
A: Number of nozzle omissions is 2 or less
B: Number of nozzle omissions is from 3 to 5
C: Number of nozzle omissions is 6 or over

TABLE 4

| | | | | | | HSP value |
|---|---|---|---|---|---|---|
| | | | | | | of organic |
| Example/ | | | | | | solvent |
| Comparative | Hansen sphere of solid content ((J/cm³)^{0.5} | | | | | alone |
| Example No. | δD | δP | δH | Radius | (a) δH − radius | (b) δH |
| Example 1 | 16.2 | 14.7 | 33.4 | 10.3 | 23.1 | 24.3 |
| Example 2 | 16.3 | 14.3 | 29.9 | 10.5 | 19.4 | 24.3 |
| Example 3 | 16.2 | 13.2 | 30.3 | 8.8 | 21.5 | 24.3 |
| Example 4 | 16.2 | 13.7 | 30.7 | 8.5 | 22.2 | 24.3 |
| Example 5 | 16.9 | 15.9 | 35.3 | 12.3 | 23.0 | 24.3 |
| Example 6 | 16.2 | 14.7 | 33.4 | 10.3 | 23.1 | 23.9 |
| Example 7 | 16.3 | 14.3 | 29.9 | 10.5 | 19.4 | 23.9 |
| Example 8 | 16.2 | 13.2 | 30.3 | 8.8 | 21.5 | 23.9 |
| Example 9 | 16.2 | 13.7 | 30.7 | 8.5 | 22.2 | 23.9 |
| Example 10 | 16.9 | 15.9 | 35.3 | 12.3 | 23.0 | 23.9 |
| Example 11 | 15.8 | 12.3 | 30.2 | 8.1 | 22.1 | 24.3 |
| Example 12 | 15.8 | 13.2 | 30.8 | 8.1 | 22.7 | 24.3 |
| Comparative | 16.2 | 13.2 | 30.3 | 8.8 | 21.5 | 21.3 |
| Example 1 | | | | | | |
| Comparative | 16.2 | 13.7 | 30.7 | 8.5 | 22.2 | 21.3 |
| Example 2 | | | | | | |
| Comparative | 15.9 | 14.1 | 32.5 | 6.7 | 25.8 | 24.3 |
| Example 3 | | | | | | |
| Comparative | 15.9 | 14.0 | 31.3 | 6.3 | 25.0 | 24.3 |
| Example 4 | | | | | | |
| Comparative | 15.7 | 13.7 | 31.1 | 6.4 | 24.7 | 24.3 |
| Example 5 | | | | | | |
| Comparative | 15.9 | 13.8 | 31.1 | 6.4 | 24.7 | 24.3 |
| Example 6 | | | | | | |
| | | | Whether HSP | | | |
| | Distance from | | value of organic | | | |
| | center point of | | solvent is within | | | |
| | Hansen sphere of | | Hansen sphere of | | | |
| | solid content | | solid content | | | |
| Example/ | Organic | | Organic | | | |
| Comparative | solvent + | Organic | solvent + | Organic | Discharging | (b) − |
| Example No. | water | solvent | water | solvent | stability | (a) |
| Example 1 | 1.8 | 10.0 | Yes | Yes | B | 1.2 |
| Example 2 | 5.1 | 6.7 | Yes | Yes | A | 4.9 |
| Example 3 | 4.7 | 6.6 | Yes | Yes | A | 2.8 |
| Example 4 | 4.3 | 7.1 | Yes | Yes | B | 2.1 |
| Example 5 | 2.1 | 12.2 | Yes | Yes | B | 1.3 |
| Example 6 | 1.4 | 9.7 | Yes | Yes | B | 0.8 |
| Example 7 | 5.0 | 6.2 | Yes | Yes | A | 4.5 |
| Example 8 | 4.8 | 6.5 | Yes | Yes | A | 2.4 |
| Example 9 | 4.3 | 6.9 | Yes | Yes | B | 1.7 |
| Example 10 | 1.4 | 11.8 | Yes | Yes | B | 0.9 |
| Example 11 | 5.1 | 6.3 | Yes | Yes | B | 2.2 |
| Example 12 | 4.3 | 7.1 | Yes | Yes | B | 1.6 |
| Comparative | 3.5 | 9.4 | Yes | No | C | −0.2 |
| Example 1 | | | | | | |
| Comparative | 3.1 | 10.0 | Yes | No | C | −0.9 |
| Example 2 | | | | | | |
| Comparative | 2.5 | 8.9 | Yes | No | C | −1.6 |
| Example 3 | | | | | | |
| Comparative | 3.7 | 7.8 | Yes | No | C | −0.8 |
| Example 4 | | | | | | |
| Comparative | 3.9 | 7.6 | Yes | No | C | −0.5 |
| Example 5 | | | | | | |
| Comparative | 3.9 | 7.6 | Yes | No | C | −0.5 |
| Example 6 | | | | | | |

The present disclosure relates to the ink of the following 1 and also includes the following 2 to 9 as embodiments.

1. An ink contains water, an organic solvent, a resin, and a pigment, wherein the organic solvent has a Hansen solubility parameter (HSP) value in the Hansen sphere in a δD axis, δP axis, and δH axis coordinate space of the solid content of the ink.
2. The ink according to 1 mentioned above, wherein the center coordinate of the Hansen sphere in the δD axis, δP axis, and OH axis coordinate space of the solid content of the ink has a δD value of from 15 to 18, axis, a δP value of from 10 to 18, and a δH value of from 27 to 38.
3. The ink according to 1 or 2 mentioned above, wherein the Hansen sphere has a radius of 15 or less in the δD axis, δP axis, and δH axis coordinate space of the solid content of the ink.
4. The ink according to any one of 1 to 3 mentioned above, wherein the solvent mixture of the water and the organic solvent in the ink has an HSP value within the Hansen sphere in the δD axis, δP axis, and δH axis coordinate space of the solid content of the ink.
5. The ink according to any one of 1 to 4 mentioned above, wherein the following relationship is satisfied: (b)−(a)≥2.4, where (b) represents the value of δH of the HSP value of the organic solvent and (a) represents the value calculated by subtracting the radius of the Hansen sphere in the δD axis, δP axis, and OH axis coordinate space of the solid content of the ink from δH of the Hansen sphere in the δD axis, δP axis, and δH axis coordinate space of the solid content of the ink.
6. The inkjet ink according to any one of 1 to 5 mentioned above contains the ink of any one of 1 to 5 mentioned above.
7. An ink container includes a container containing the ink of any one of 1 to 5 mentioned above.
8. A method of forming images includes applying the ink of any one of 1 to 5 mentioned above to a recording medium.
9. An image forming device includes the ink container 7 mentioned above and a discharging device configured to discharge the ink supplied from the ink container.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An ink comprising:
water;
an organic solvent;
a resin; and
a pigment,
wherein the organic solvent has a Hansen solubility parameter (HSP) value in a Hansen sphere in a δD axis, δP axis, and δH axis coordinate space of a solid content of the ink.

2. The ink according to claim 1, wherein a center coordinate of the Hansen sphere has a δD value of from 15 to 18, a δP value of from 10 to 18, and a δH value of from 27 to 38.

3. The ink according to claim 1, wherein the Hansen sphere has a radius of 15 or less.

4. The ink according to claim 1, wherein a solvent mixture of the water and the organic solvent has an HSP value in the Hansen sphere in the δD axis, δP axis, and δH axis coordinate space of the solid content of the ink.

5. The ink according to claim 1, wherein the following relationship is satisfied: (b)−(a)≥2.4, where (b) represents a value of OH of the HSP value of the organic solvent and (a) represents a value calculated by subtracting a radius of the Hansen sphere in the δD axis, δP axis, and δH axis coordinate space of the solid content of the ink from OH of the Hansen sphere in the δD axis, δP axis, and δH axis coordinate space of the solid content of the ink.

6. An inkjet ink comprising:
the ink of claim 1.

7. An ink container comprising:
a container containing the ink of claim 1.

8. An image forming method comprising:
applying the ink of claim 1 to a recording medium.

9. An image forming device comprising:
an ink container including a container containing the ink of claim 1; and
a discharging device configured to discharge the ink supplied from the ink container.
